(19) United States
(12) Patent Application Publication
(10) Pub. No.: US 2015/0323453 A1
(43) Pub. Date: Nov. 12, 2015

(54) VOID-ARRANGED STRUCTURE AND MEASUREMENT METHOD

(71) Applicant: Murata Manufacturing Co., Ltd., Nagaokakyo-shi (JP)

(72) Inventors: SEIJI KAMBA, Nagaokakyo-shi (JP); Takashi Kondo, Nagaokakyo-shi (JP)

(21) Appl. No.: 14/801,119

(22) Filed: Jul. 16, 2015

Related U.S. Application Data
(63) Continuation of application No. PCT/JP2014/051493, filed on Jan. 24, 2014.

(30) Foreign Application Priority Data
Feb. 27, 2013 (JP) 2013-036662

(51) Int. Cl. G01N 21/47; G01N 21/03

(52) U.S. Cl. CPC G01N 21/47; G01N 21/03

(57) ABSTRACT

A void-arranged structure having a plurality of void sections that penetrate from a first principal surface toward a second principal surface. An opening shape of the void section includes at least one curved corner.

### CROSS REFERENCE TO RELATED APPLICATIONS

The present application is a continuation of International application No. PCT/JP2014/051493, filed Jan. 24, 2014, which claims priority to Japanese Patent Application No. 2013-036662, filed Feb. 27, 2013, the entire contents of each of which are incorporated herein by reference.

### FIELD OF THE INVENTION

The present invention relates to a void-arranged structure and a measurement method for measuring a measurement target object by irradiating, with electromagnetic waves, the void-arranged structure holding the measurement target object thereon.

### BACKGROUND OF THE INVENTION

A measurement method in which a measurement target object is disposed on a void-arranged structure and the measurement target object is measured by irradiation of electromagnetic waves has been known. For example, Patent Document 1 discloses an example of this kind of measurement method. In Patent Document 1, a void-arranged structure configured of a mesh-like conductive plate or the like is used. A measurement target object is held on a principal surface of the void-arranged structure. The principal surface of the void-arranged structure is irradiated with electromagnetic waves. Electromagnetic waves having passed the void-arranged structure are detected. A dip waveform is observed in frequency characteristics of the detected electromagnetic waves. The dip waveform refers to a waveform which is generated within a pass band in a transmission spectrum of the electromagnetic waves and exhibits a rapid decrease in transmittance. Note that the pass band refers to a region where transmittance is high in the transmission spectrum. As such, in the case where a dip waveform is present within the pass band, a degree of decrease in transmittance can be confirmed in the dip waveform.

Because the above-mentioned dip waveform changes depending on presence/absence of a measurement target object, the measurement target object can be detected.

Patent Document 1: Japanese Unexamined Patent Application Publication No. 2008-185552

### SUMMARY OF THE INVENTION

However, Patent Document 1 does not disclose a method for adjusting a frequency position of the dip waveform. There is a case where the frequency position of a dip waveform is significantly shifted depending on the configuration of a void-arranged structure. In a special case, the dip waveform is shifted to the outside of the pass band so that the degree of decrease in transmittance cannot be detected in the dip waveform.

A measurement method that detects a peak waveform, not a dip waveform, by making use of reflection of electromagnetic waves, not the transmission thereof, is also known. In this measurement method that detects a peak waveform, there is also a case where a frequency position of the peak waveform is shifted to the outside of the pass band depending on the configuration of a void-arranged structure.

An object of the present invention is to provide a void-arranged structure and a measurement method using the stated void-arranged structure capable of adjusting frequency positions of a dip waveform, a peak waveform, and the like.

A void-arranged structure according to an aspect of the present invention is used for measuring a measurement target object, which is being held thereon, by irradiation of electromagnetic waves. The void-arranged structure includes a first principal surface and a second principal surface opposing the first principal surface. The void-arranged structure has a plurality of void sections. The plurality of void sections penetrate from the first principal surface toward the second principal surface. In an aspect of the present invention, an opening shape of the void section includes at least one corner. In the corner, straight line portions located on both sides of the corner are linked to each other with a curved line portion.

In the void-arranged structure of the present invention, it is preferable for the curved line portion to be located at an inner side portion with respect to a virtual corner that is formed when the straight line portions on both the sides are extended and joined together.

Further, in the present invention, it is preferable for the curved line portion to be located at an outer side portion with respect to the virtual corner that is formed when the straight line portions on both the sides are extended and joined together.

In the void-arranged structure of the present invention, it is preferable that a plurality of corners be provided and that all the corners include the curved line portion mentioned above.

It is preferable for the opening shape of the void section to be a regular polygon, and more preferable to be a square in the present invention.

A measurement method according to another aspect of the present invention uses a void-arranged structure conforming to the configuration of the present invention. The measurement method according to an aspect of the present invention includes preparing a void-arranged structure in which a plurality of void sections are provided and a shape of the above-mentioned curved line portion is adjusted in at least one corner; irradiating the void-arranged structure with electromagnetic waves after having adjusted the shape of the curved line portion; irradiating the void-arranged structure, which has experienced the adjustment of the shape of the curved line portion, with electromagnetic waves in a state in which a measurement target object is held on the void-arranged structure, and detecting scattered electromagnetic waves; and measuring the measurement target object based on a difference between the scattered electromagnetic waves before the measurement target object being held and the scattered electromagnetic waves after the measurement target object having been held.

In the void-arranged structure according to an aspect of the present invention, because in at least one corner of a cavity, straight line portions located on both sides of the corner are linked to each other with a curved line portion, adjusting a shape of the curved line portion makes it possible to adjust frequency positions of a dip wave, a peak wave, and the like. As such, by analyzing a transmission spectrum or a reflection spectrum of electromagnetic waves, the measurement target object can be detected with certainty.

### BRIEF DESCRIPTION OF THE DRAWINGS

FIG. 1(a) and FIG. 1(b) are a perspective view of a void-arranged structure according to a first embodiment of the present invention and a partial-cutout enlarged elevation view illustrating a main part thereof, respectively.

FIG. 2 is a transmittance-frequency characteristic diagram illustrating a change in frequency position of a dip waveform in the case where a shape of a curved line portion is changed in the void-arranged structure according to the first embodiment of the present invention.

FIG. 3 is a schematic enlarged elevation view for explaining mechanism that makes a frequency position of a dip waveform change in the first embodiment of the present invention.

FIG. 4 is a partial-cutout enlarged elevation view for explaining a variation on the first embodiment.

FIG. 5 is a partial-cutout enlarged elevation view for explaining another variation on the first embodiment.

FIG. 6(a) and FIG. 6(b) are elevation views respectively illustrating variations on an opening shape of a void section.

FIG. 7 is a plan view for explaining another variation on an opening shape of a void section.

FIG. 8 is a general configuration diagram for explaining a measurement apparatus using the void-arranged structure of the present invention.

### DETAILED DESCRIPTION OF THE PREFERRED EMBODIMENTS

Hereinafter, the present invention will be clarified through descriptions of specific embodiments of the present invention with reference to the drawings.

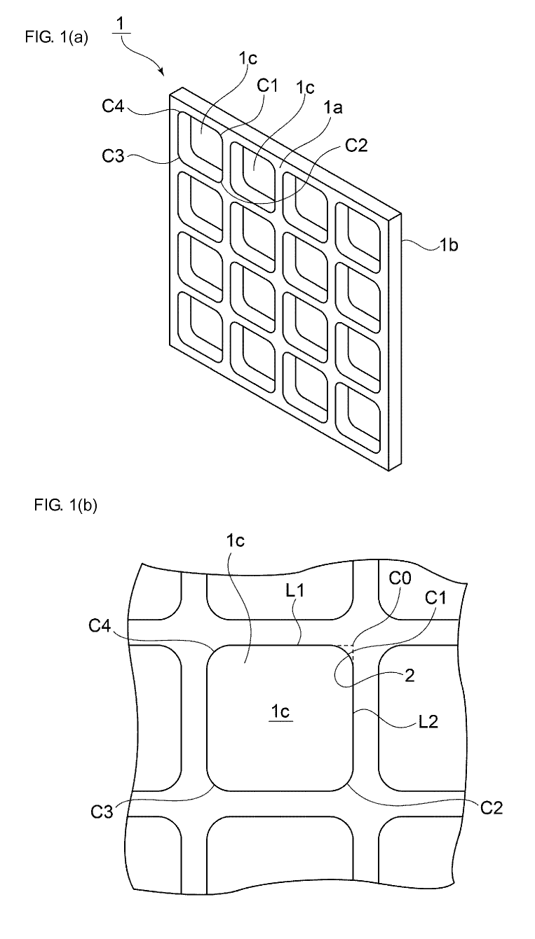

FIG. 1(a) is a perspective view of a void-arranged structure according to an embodiment of the present invention, and FIG. 1(b) is a partial-cutout enlarged elevation view illustrating a main part thereof.

In the present embodiment, a void-arranged structure 1 has a rectangular plate-like shape. Note that a planar shape of the void-arranged structure 1 is not limited to any specific type, and may be a shape other than a rectangle.

The void-arranged structure 1 has a first principal surface 1a and a second principal surface 1b opposing the first principal surface 1a.

A plurality of void sections 1c are formed penetrating from the first principal surface 1a through the second principal surface 1b in the void-arranged structure 1.

The plurality of void sections 1c are periodically arranged on the first principal surface 1a. In the present embodiment, the plurality of void sections 1c are arranged in matrix form having a plurality of rows and a plurality of columns. Note that, however, the periodical arrangement structure is not intended to be limited to a matrix-form arrangement structure.

Although the material of the void-arranged structure 1 is not limited to any specific one, the void-arranged structure 1 is made of a material with low electric resistance. To be more specific, it can be configured using a metal, a semiconductor, or the like. More preferably, a metal is used. As the material, gold, silver, copper, iron, nickel, tungsten, or an alloy of various metals can be cited. The void-arranged structure 1 may be formed by coating a surface of an insulative material with a conductive material.

One of features of the void-arranged structure 1 is an opening shape of the void section 1c. As shown in FIG. 1(b), the opening shape of the void section 1c is substantially square when viewed from the first principal surface 1a side. As such, this opening shape has four corners C1 through C4. The present embodiment is characterized in that a plurality of the corners C1 through C4 are each rounded. The configuration in which the corners are rounded will be described below taking the corner C1 as a representative.

In the corner C1, a first straight line portion L1 and a second straight line portion L2, which are the sides located on both sides of the corner C1, are linked to each other with a curved line portion 2. That is to say, the curved line portion 2 is formed by rounding the corner. In the case where the rounding is not carried out, a corner C0 is formed as indicated by a broken line. In other words, the corner C0, which is a virtual corner, is formed by connecting the straight line portion L1 and the straight line portion L2 so that these lines are orthogonal to each other. In contrast, in the present embodiment, the above-mentioned curved line portion 2 is located at an inner side portion with respect to the corner C0.

Likewise, in the remaining corners C2 through C4, straight line portions on both sides of each of the corners C2 through C4 are linked to each other with each curved line portion 2.

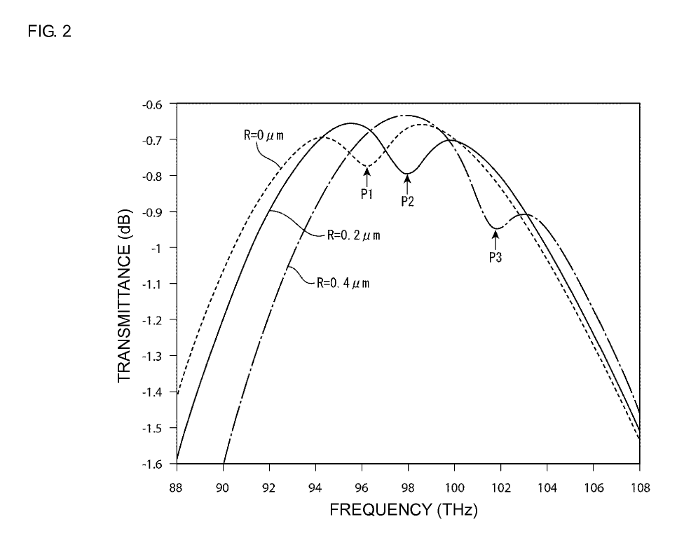

In the present embodiment, because each of the four corners C1 through C4 is so rounded as to include the curved line portion 2 in the void section 1c as described above, it is possible to easily adjust a frequency position of the dip waveform at a time of measuring a measurement target object. This will be explained below referring to FIG. 2. Here, FIG. 2 is a diagram illustrating transmittance-frequency characteristics of electromagnetic waves in the respective void-arranged structures according to working examples 1, 2 and a comparative example explained below.

In the working examples 1 and 2, the void-arranged structure 1 was formed of a material made of Ni, the overall shape thereof was circular, and dimensions thereof were 6 mm in diameter and 0.6 μm in thickness. Further, an opening dimension of one void section 1c, in other words, a distance between the sides opposing each other was set to be 1.8 μm. A pitch of the plurality of cavities 1c was set to be 2.6 μm. In the working examples 1 and 2, a curvature radius R of the curved line portion 2 was varied as described below. Furthermore, as the comparative example, there was prepared a structure similar to the structure of the working example 1 except that R=0 μm, in other words, the curved line portion was not included therein.

Comparative example: R=0 μm

Working example 1: R=0.2 μm

Working example 2: R=0.4 μm

Each of the void-arranged structures 1 of the working examples 1, 2 and the comparative example was irradiated with electromagnetic wave pulses having frequencies in a range from 88 to 108 THz so as to measure the transmittance-frequency characteristics of the electromagnetic waves. As a result, a measurement result shown in FIG. 2 was obtained.

As is clear from FIG. 2, it can be understood that frequency positions of dip waveforms indicated by arrows P1 through P3, which are observed in the respective transmittance-frequency characteristic curves, change in the case where the curvature of the curved line portion 2 is changed. In FIG. 2, a minimum point of the dip waveform indicated by the arrow P1 is positioned at a frequency of 96.245 THz, a minimum point of the dip waveform indicated by the arrow P2 is positioned at a frequency of 97.966 THz, and a minimum point of the dip waveform indicated by the arrow P3 is positioned at a frequency of 101.878 THz.

Accordingly, it can be understood that the frequency position of the dip waveform can be changed by changing the shape of the curved line portion 2. Meanwhile, as is clear from FIG. 2, a frequency range where the transmittance is high lies in the vicinity of approximately 94 to 100.5 THz in the void-arranged structure 1. This is the frequency range where the transmittance is no more than −0.7 dB. Such frequency range where the transmittance is high is employed as the pass band mentioned before.

Accordingly, in the case where a dip waveform is present in the pass band, a measurement target object can be detected with high precision in accordance with a degree of decrease in transmittance.

As such, according to the present embodiment, adjusting the curvature of the curved line portion 2 makes it possible to measure the measurement target object with certainty.

It is to be noted that the present invention is not limited to detection of the above-discussed transmission spectrum, in other words, detection of scattered electromagnetic waves generated due to forward scattering of the electromagnetic waves. Reflected electromagnetic waves as backward scattering of the electromagnetic waves may be detected instead. That is, electromagnetic waves may be emitted toward the first principal surface 1a of the void-arranged structure 1 and magnetic waves reflected by the void-arranged structure 1, in other words, backward-scattered electromagnetic waves may be detected. In this case, the measurement target object can be detected by magnitude of a peak waveform, not by the dip waveform. Also in the case where such peak waveform is detected, a frequency position of the peak waveform can be adjusted by changing the shape of the curved line portion 2.

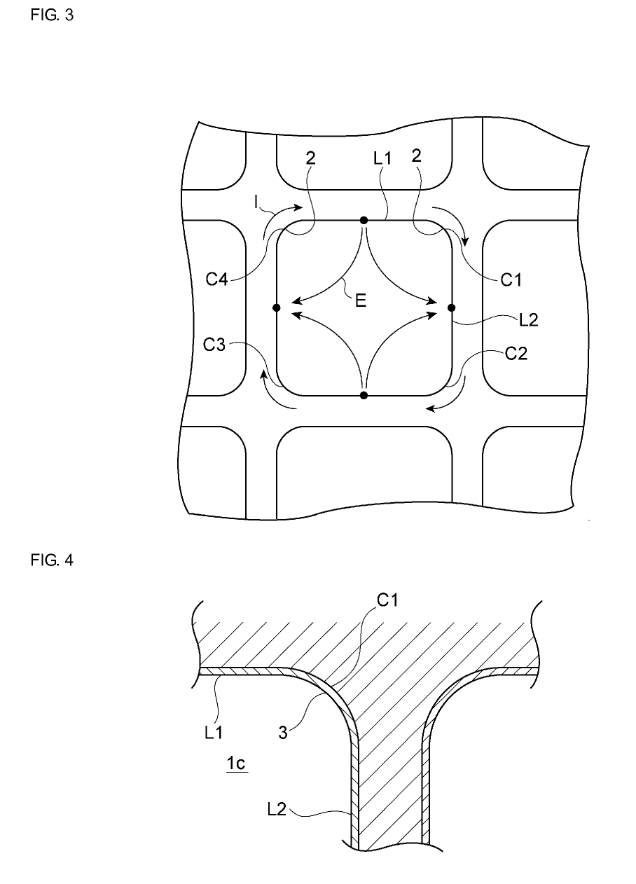

In the above embodiment, the reason why changing the shape of the curved line portion 2 makes the frequency position of the dip waveform change can be conceived as follows. That is, as shown in FIG. 3, when the void section 1c is irradiated with electromagnetic waves, an LC resonance phenomenon is generated in the void section 1c. In this case, a radio wave vector of a resonance electric field E takes a direction indicated by an arrow in FIG. 3. Meanwhile, on the corners C1 through C4, a resonance current I flows through conductive portions of the corners C1 through C4 as shown in FIG. 3.

In the case where the shape of the curved line portion 2 is changed, an area of a current path through which the resonance current I flows changes. This changes a value of inductance L. In the case where the curved line portion 2 is located at an inner side portion with respect to the virtual corner C0 like in this embodiment, the inductance L is made to be smaller. As such, it can be thought that the frequency position of the dip waveform is made to be higher.

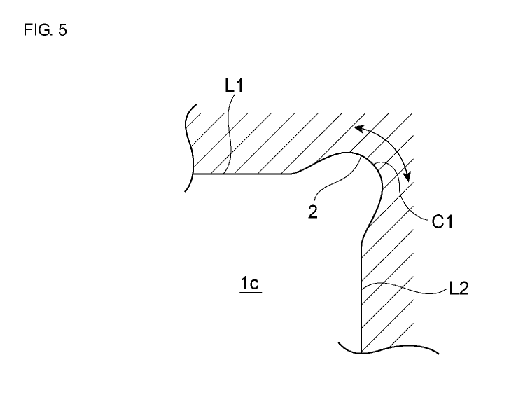

Conversely, like in a variation indicated by a partial-cutout enlarged elevation view in FIG. 5, in the case where on the corner 1, the curved line portion 2 is located at an outer side portion with respect to the virtual corner C0, the inductance L is made to be larger. With this, the resonant frequency is made to be lower and the frequency position of the dip waveform is lowered.

As such, according to the present embodiment, by adjusting the shape of the curved line portion 2, the frequency positions of the dip waveform, peak waveform, and the like can be adjusted with ease.

Further, in the void-arranged structure 1 of the present embodiment, because the corners C1 through C4 are rounded, the mechanical strength is enhanced. The void-arranged structure 1 is made of a thin member and is extended to be fixed to another portion in many cases. In such case, stress is applied to the corners C1 through C4 of the void section 1c during being extended. As such, if the corners are not rounded, they are likely to be damaged by the stress. In contrast, in the present embodiment, since the corners C1 through C4 are rounded, in other words, the curved line portions 2 are included, the above stress can be lessened. Accordingly, it is possible to effectively suppress the damage during the extension.

In addition, like in a variation shown in FIG. 4, a coating layer 3 made of a conductive material or the like is provided in the void-arrange structure 1. In this case, rounding the corner C1 increases fluidity of the coating liquid. As such, coating can be surely carried out on an inner side surface of the corner C1.

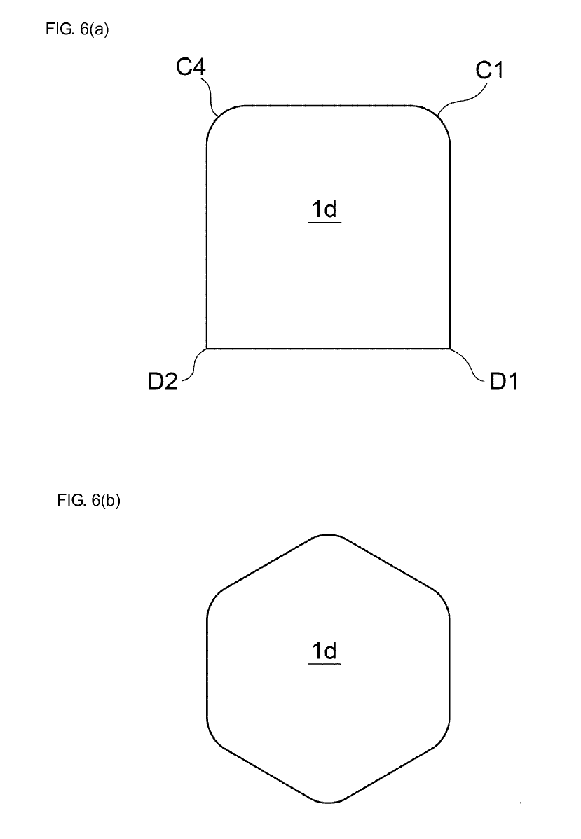

FIG. 6(a) and FIG. 6(b) are elevation views respectively illustrating variations on the opening shape of the void section 1c of the present invention.

As for a void section 1d shown in FIG. 6(a), in a substantially square opening shape, two corners C1 and C4 are rounded in the same manner as in the above embodiment so as to include curved line portions. On the contrary, two corners D1 and D2 are not rounded. That is, these corners are the same as a corner with an internal angle of 90 degrees. As discussed above, in the case where the opening shape includes a plurality of the corners C1, C4, D1, and D2, all the corners C1, C4, D1, and D2 are not needed to include the curved line portion. In other words, it may be sufficient that, in at least one corner, the straight line portions on both sides of the corner are linked to each other with the curved line portion.

Further, like the void section 1d shown in FIG. 6(b), the overall shape may be a substantially regular hexagon. Also in this case, in each corner, the straight line portions on both sides of the corner are linked to each other with the curved line portion. That is, the corners are rounded. Note that the shape thereof is not limited to a regular hexagon, and may be another regular polygon such as a regular tetragon like the above-mentioned square, a regular octagon, or the like. Furthermore, the opening shape may not be limited to a regular polygon, and may be another type of polygon.

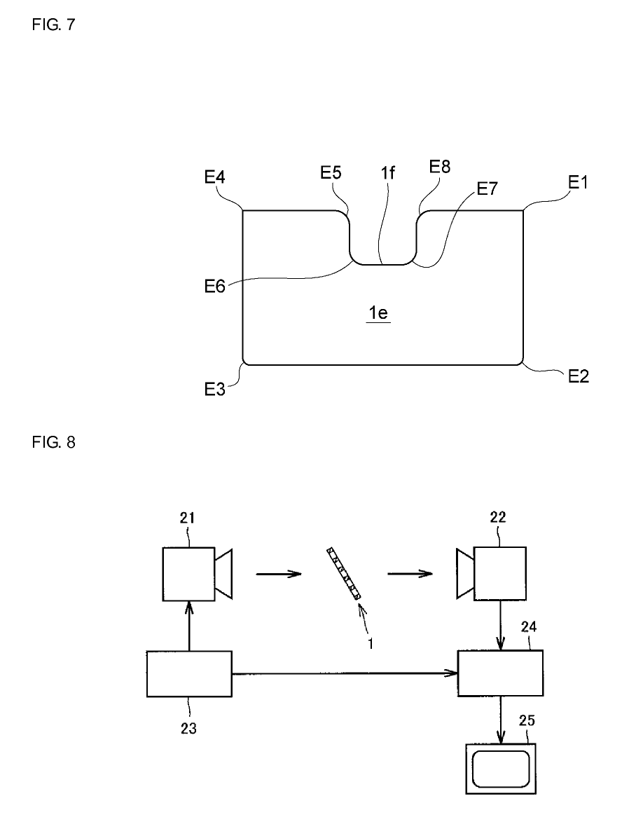

Moreover, like a void section 1e shown in FIG. 7, a substantially rectangular opening shape may include a recess 1f. Here, since the recess 1f is provided in one side of the rectangle, the opening shape has corners E1 through E8. Also in this case, it is sufficient that at least one corner among the corners E1 through E8 is rounded so that the straight line portions on both sides of the corner are linked to the curved line portion.

In the case where the shapes of the corners E6 and E7 in the recess 1f are changed, capacitance C changes when a resonance current flows, and it can be considered that the change in the capacitance C causes the frequency positions of the dip waveform and the peak waveform to be changed.

As described thus far, in the present invention, the corners include the corresponding curved line portions so as to change the capacitance C that defines a resonant frequency, whereby the frequency positions of the dip waveform, peak waveform, and the like may be adjusted.

The above-described void-arranged structure 1 is employed in a conventionally known measurement method using electromagnetic waves as disclosed in Patent Document 1. In this measurement method, measurement can be carried out using a measurement apparatus as shown in FIG. 8.

This measurement apparatus includes an emitting unit 21 for emitting electromagnetic waves and a detection unit 22 for detecting electromagnetic waves scattered in the void-arranged structure 1. The measurement apparatus further includes an emission control unit 23 for controlling operations of the emitting unit 21 and an analysis processing unit 24 configured to process a detection result from the detection unit 22. A display unit 25 configured to display an analysis result is connected to the analysis processing unit 24.

Note that the term “scattering” means a broad concept including transmission as one mode of forward scattering, reflection as one mode of backward scattering, and the like, as discussed before. It is preferable to mean transmission or reflection, and more preferable to mean transmission in a zero-order direction, reflection in a zero-order direction, and the like.

In general, in the case where a grating interval of a diffraction grating (corresponds to an interval of a void section in the present specification) is taken as “d”, an incident angle is taken as “i”, a diffraction angle is taken as θ, and a wave length is taken as λ, a spectrum diffracted by the diffraction grating can be represented as follows.

d(sin i−sin θ)=nλ Formula (1)

Here, “zero-order” in the expression “zero-order direction” indicates a case in which n is 0 in Formula (1). Because neither d nor λ, can be 0, n=0 holds only when (sin i−sin θ) equals 0. Accordingly, the expression “zero-order direction” corresponds to a state in which the incident angle is equal to the diffraction angle, in other words, means a direction along which the electromagnetic waves travel without changing the travelling direction thereof.

The void-arranged structure 1 is irradiated with electromagnetic waves emitted from the emitting unit 21 under the control of the emission control unit 23. Electromagnetic waves having passed the void-arranged structure 1 are detected by the detection unit 22. The electromagnetic waves detected by the detection unit 22 are converted to an electric signal and the signal is supplied to the analysis processing unit 24. Then, frequency characteristics of transmittance are displayed on the display unit 25.

Next, a measurement target object is held on a principal surface of the void-arranged structure 1. Then, the above-mentioned electromagnetic wave pulses are emitted to carry out the measurement again. In the case where the measurement target object is present, transmittance is lowered. That is, transmittance in the dip waveform is significantly lowered. As such, quantity, physical properties, and the like of the measurement target object can be detected in accordance with a degree of decrease in transmittance in the dip waveform.

In an embodiment of a measurement method of the present invention, a shape of the curved line portion 2 is adjusted in at least one corner C1 prior to carrying out the measurement described above. Thereafter, the void-arranged structure 1 in which the shape of the curved line portion 2 has been adjusted is irradiated with electromagnetic waves. Then, the scattered electromagnetic waves are detected. The scattering in this case may be, as described before, forward scattering or backward scattering. Next, a measurement target object is held on the void-arranged structure 1 in which the shape of the curved line portion 2 has been adjusted, and electromagnetic waves are emitted thereto. Then, the measurement target object is measured based on a difference between the scattered electromagnetic waves before the measurement target object being held and the scattered electromagnetic waves after the object having been held.

As such, by adjusting the shape of the curved line portion 2 in advance as described above, it is possible to allow the frequency positions of a dip waveform, a peak waveform, and the like to lie within a pass band with certainty. With this, a measurement target object can be measured at a high level of precision.

### REFERENCE SIGNS LIST

1 VOID-ARRANGED STRUCTURE
1a FIRST PRINCIPAL SURFACE
1b SECOND PRINCIPAL SURFACE
1c, 1d, 1e VOID SECTION
1f RECESS
2 CURVED LINE PORTION
3 COATING LAYER
21 EMITTING UNIT
22 DETECTION UNIT
23 EMISSION CONTROL UNIT
24 ANALYSIS PROCESSING UNIT
25 DISPLAY UNIT
C0-C4 CORNER
D1, D2 CORNER
E1-E8 CORNER
L1 FIRST STRAIGHT LINE PORTION
L2 SECOND STRAIGHT LINE PORTION

1. A void-arranged structure, comprising:
a body having a first principal surface, a second principal surface opposing the first principal surface, and a plurality of void sections penetrating from the first principal surface toward the second principal surface,
wherein an opening shape of the void section includes at least one curved corner linking straight line portions located on opposed sides of the curved corner.

2. The void-arranged structure according to claim 1,
wherein the curved corner is located at an inner side portion with respect to a virtual corner that is defined when the straight line portions on the opposed sides of the curved corner are extended and joined together.

3. The void-arranged structure according to claim 1,
wherein the curved corner is located at an outer side portion with respect to the virtual corner that is defined when the straight line portions on the opposed sides of the curved corner are extended and joined together.

4. The void-arranged structure according to claim 1,
wherein the opening shape includes a plurality of the curved corners.

5. The void-arranged structure according to claim 4,
wherein all corners of the opening shape are curved corners.

6. The void-arranged structure according to claim 1,
wherein the opening shape of the void section is a regular polygon.

7. The void-arranged structure according to claim 6,
wherein the opening shape is a square.

8. The void-arranged structure according to claim 6,
wherein the opening shape is a hexagon.

9. The void-arranged structure according to claim 1, further comprising:
a conductive material coating layer on an inner side surface of the opening shape.

10. The void-arranged structure according to claim 6,
wherein the opening shape includes a recess portion on at least one side of the opening shape.

11. A measurement method comprising:
preparing a void-arranged structure having a first principal surface, a second principal surface opposing the first principal surface, and a plurality of void sections penetrating from the first principal surface toward the second principal surface, wherein an opening shape of the void section includes at least one curved corner linking straight line portions located on opposed sides of the curved corner;
irradiating the void-arranged structure with electromagnetic waves without a measurement target object thereon and detecting first scattered electromagnetic waves;
placing a measurement target object on the void-arranged structure;
irradiating the void-arranged structure with the electromagnetic waves in a state in which the measurement target object is held thereon and detecting second scattered electromagnetic waves; and
measuring the measurement target object based on a difference between the first scattered electromagnetic waves and the second scattered electromagnetic waves.

12. The measurement method according to claim 11, the method further comprising:
adjusting a shape of the curved corner such that a frequency position of a waveform is within a pass band in a transmission spectrum of the electromagnetic waves.

13. The measurement method according to claim 12,
wherein the waveform is a dip waveform.

14. The measurement method according to claim 12,
wherein the waveform is a peak waveform.

15. The measurement method according to claim 11,
wherein the curved corner is located at an inner side portion with respect to a virtual corner that is defined when the straight line portions on the opposed sides of the curved corner are extended and joined together.

16. The measurement method according to claim 11,
wherein the curved corner is located at an outer side portion with respect to the virtual corner that is defined when the straight line portions on the opposed sides of the curved corner are extended and joined together.

17. The measurement method according to claim 11, the method further comprising:
providing a conductive material coating layer on an inner side surface of the opening shape.
